(19) United States
(12) Patent Application Publication
(10) Pub. No.: US 2014/0265868 A1
(43) Pub. Date: Sep. 18, 2014

(54) Lighting Calibration for Intensity and Color

(71) Applicant: LSI INDUSTRIES, INC, Cincinnati, OH (US)

(72) Inventor: Marc Morrisseau, Montreal (CA)

(21) Appl. No.: 13/931,482

(22) Filed: Jun. 28, 2013

Related U.S. Application Data
(60) Provisional application No. 61/790,700, filed on Mar. 15, 2013.

(51) Int. Cl. H05B 33/08

(52) U.S. Cl. CPC H05B 33/0842
USPC 315/151

(57) ABSTRACT

Systems and methods for lighting calibration are disclosed. A brightness level for a first color, a brightness level for a second color, and a brightness level for a third color are detected for at least a portion of the plurality of light sources. A desired brightness value for the first color is determined based on the detected brightness level for the first color. A desired brightness value for the second color is determined based on the detected brightness level for the second color. A desired brightness value for the third color is determined based on the detected brightness level for the third color. One or more currents are adjusted at the plurality of light sources to set the plurality of light sources to the desired brightness value for the first color, the desired brightness value for the second color, and the desired brightness value for the third color.

### CROSS REFERENCE TO RELATED APPLICATION

This application claims priority under 35 U.S. C. §119(e) and the benefit of U.S. Provisional Application No. 61/790,700, filed Mar. 15, 2013, and entitled, “LIGHTING CALIBRATION FOR INTENSITY AND COLOR,” the entire disclosure of which is incorporated herein by reference.

### BACKGROUND

The subject technology generally relates to lighting interfaces and, in particular, relates to lighting interfaces for intensity and color.

Oftentimes, lighting systems include multiple lighting sources. For example, a LED display system used in a stadium or on an outside wall of a building can have multiple LED boards, each of which includes multiple LED blocks. The LED blocks or LED boards may decay at different rates or be replaced at different times, causing different LED blocks or LED boards to exhibit different light intensities (e.g., one block may be brighter than another when both blocks are set to the same brightness level) or different color intensities (e.g., the same image, having the same colors, may be displayed with different color intensities on different LED boards or LED blocks). The different color intensities and different light intensities are not viewer friendly and may cause an appearance, to the viewer, that the system is not functioning correctly.

Repairing the divergence in light or color intensities may require the effort of a highly skilled and highly compensated technician who manually adjusts the color and light intensities to match one another. The technician may use an expensive camera to ensure that the colors and light intensities of different light sources match one another. As a result, owners of LED display systems may forego repairing this divergence, causing a non-viewer friendly experience, or may spend lots of money and worker-hours for the repairs. As the foregoing illustrates, a new approach for lighting calibration for intensity and color may be desirable.

### SUMMARY

In some aspects, the disclosed subject matter relates to a computer-implemented method for calibrating brightness among a plurality of light sources. The method includes detecting a brightness level for a first color, a brightness level for a second color, and a brightness level for a third color for at least a portion of the plurality of light sources. The method includes determining a desired brightness value for the first color based on the detected brightness level for the first color. The method includes determining a desired brightness value for the second color based on the detected brightness level for the second color. The method includes determining a desired brightness value for the third color based on the detected brightness level for the third color. The method includes adjusting one or more currents at the plurality of light sources to set the plurality of light sources to the desired brightness value for the first color, the desired brightness value for the second color, and the desired brightness value for the third color.

In some aspects, the disclosed subject matter relates to a non-transitory computer-readable medium including instructions to calibrate brightness among a plurality of light sources. The instructions include code to detect a brightness level for a first color, a brightness level for a second color, and a brightness level for a third color for at least a portion of the plurality of light sources. The instructions include code to determine a desired brightness value for the first color based on the detected brightness level for the first color. The instructions include code to determine a desired brightness value for the second color based on the detected brightness level for the second color. The instructions include code to determine a desired brightness value for the third color based on the detected brightness level for the third color. The instructions include code to adjust one or more currents at the plurality of light sources to set the plurality of light sources to the desired brightness value for the first color, the desired brightness value for the second color, and the desired brightness value for the third color.

In some aspects, the disclosed subject matter relates to a system. The system includes one or more processors and a memory. The memory includes instructions to calibrate brightness among a plurality of light sources. The instructions include code to detect a brightness level for a first color, a brightness level for a second color, and a brightness level for a third color for at least a portion of the plurality of light sources. The instructions include code to determine a desired brightness value for the first color based on the detected brightness level for the first color. The instructions include code to determine a desired brightness value for the second color based on the detected brightness level for the second color. The instructions include code to determine a desired brightness value for the third color based on the detected brightness level for the third color. The instructions include code to adjust one or more currents at the plurality of light sources to set the plurality of light sources to the desired brightness value for the first color, the desired brightness value for the second color, and the desired brightness value for the third color.

In some aspects, the disclosed subject matter relates to a computer-implemented method for calibrating color output among a plurality of light sources. The method includes setting each of a plurality of light sources to provide light of a first color. The method includes determining, using a color meter, a first color value for each of the plurality of light sources, where the first color value for a particular light source from among the plurality of light sources corresponds to a color output from the particular light source responsive to setting the particular light source to provide the light of the first color. The method includes setting each of the plurality of light sources to provide light of a second color. The method includes determining, using the color meter, a second color value for each of the plurality of light sources, where the second color value for the particular light source corresponds to a color output from the particular light source responsive to setting the particular light source to provide the light of the second color. The method includes setting each of the plurality of light sources to provide light of a third color. The method includes determining, using the color meter, a third color value for each of the plurality of light sources, where the third color value for a particular light source corresponds to a color output from the particular light source responsive to setting the particular light source to provide the light of the third color. The method includes storing the first color value, the second color value, and the third color value for each of the plurality of light sources, where the first color value for the particular light source, the second color value for the particular light source, and the third color value for the particular light source are stored in a data store coupled with the particular light source.

In some aspects, the disclosed subject matter relates to a non-transitory computer-readable medium including instructions to calibrate color output among a plurality of light sources. The instructions include code to set each of a plurality of light sources to provide light of a first color. The instructions include code to determine, using a color meter, a first color value for each of the plurality of light sources, where the first color value for a particular light source from among the plurality of light sources corresponds to a color output from the particular light source responsive to setting the particular light source to provide the light of the first color. The instructions include code to set each of the plurality of light sources to provide light of a second color. The instructions include code to determine, using the color meter, a second color value for each of the plurality of light sources, where the second color value for the particular light source corresponds to a color output from the particular light source responsive to setting the particular light source to provide the light of the second color. The instructions include code to set each of the plurality of light sources to provide light of a third color. The instructions include code to determine, using the color meter, a third color value for each of the plurality of light sources, where the third color value for a particular light source corresponds to a color output from the particular light source responsive to setting the particular light source to provide the light of the third color. The instructions include code to store the first color value, the second color value, and the third color value for each of the plurality of light sources, where the first color value for the particular light source, the second color value for the particular light source, and the third color value for the particular light source are stored in a data store coupled with the particular light source.

In some aspects, the disclosed subject matter relates to a system. The system includes one or more processors and a memory. The memory includes instructions to calibrate color output among a plurality of light sources. The instructions include code to set each of a plurality of light sources to provide light of a first color. The instructions include code to determine, using a color meter, a first color value for each of the plurality of light sources, where the first color value for a particular light source from among the plurality of light sources corresponds to a color output from the particular light source responsive to setting the particular light source to provide the light of the first color. The instructions include code to set each of the plurality of light sources to provide light of a second color. The instructions include code to determine, using the color meter, a second color value for each of the plurality of light sources, where the second color value for the particular light source corresponds to a color output from the particular light source responsive to setting the particular light source to provide the light of the second color. The instructions include code to set each of the plurality of light sources to provide light of a third color. The instructions include code to determine, using the color meter, a third color value for each of the plurality of light sources, where the third color value for a particular light source corresponds to a color output from the particular light source responsive to setting the particular light source to provide the light of the third color. The instructions include code to store the first color value, the second color value, and the third color value for each of the plurality of light sources, where the first color value for the particular light source, the second color value for the particular light source, and the third color value for the particular light source are stored in a data store coupled with the particular light source.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1 illustrates an example of a system for lighting calibration.

FIG. 2 illustrates an example of the control machine of FIG. 1.

FIG. 3 illustrates an example process for lighting calibration.

FIG. 4 illustrates an example of the light structure of FIG. 1.

FIG. 5 illustrates an example of the light source of FIG. 4.

FIG. 6 illustrates an example process for calibrating brightness among multiple light sources.

FIGS. 7A-7B illustrates an example process for calibrating color output among multiple light sources.

FIG. 8 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

The subject technology, in some implementations, relates to calibrating color output among multiple light sources (e.g., in a light emitting diode (LED) display unit including multiple LED boards with multiple LED blocks, with each LED block itself having a number of LEDs). Because of variances in manufacturing conditions (e.g., thickness of P-N junction, internal resistance due to material thickness, etc. for the case of LEDs) light sources having the same nominal specified characteristics will nevertheless exhibit some variances in optical output. In some environments and applications, such variances may be tolerable; in others, they may be tolerable to a lesser degree or not at all.

In some implementations, it may be desirable to calibrate the light output of the multiple light sources. For example, in a production or manufacturing environment, it may be desired to calibrate an intensity level and/or color (e.g., wavelength range) of the output for all light sources (e.g., LEDs) in a set of light sources. Such calibration can allow each light source to produce an output within a desired range or ranges for one or more optical parameters such as intensity and wavelength. Such calibration may be advantageous where high uniformity is needed, e.g., large scale LED display boards such as used at outdoor sporting events or indoor arenas. Such light sources, for which calibration may be advantageously used, are one that include red, green, and blue LEDs, grouped together (one color per group), as may be done to allow for each group to produce light of a desired color across most or virtually the entire visible spectrum of visible light.

Taking such groupings of three LEDs as an example, for calibration, for each primary color, red, green, and blue, a brightness level for the multiple light sources is detected for a given power condition (e.g., applied voltage). The brightness level is set, for the primary color, for each of the multiple light sources, to a brightness value selected based on the detected brightness levels for the primary color. This process can be used to derive or measure a calibration factor or factors for that individual red LED. This calibration factor or factors can be stored in a memory or repository and used for subsequent use of the light source, such as when applying power to the light source under intended use conditions. For example, for calibration, the brightness level for red light can be set to 200 lumens, measured at a certain distance from the red LED. If a certain voltage is initially applied to the red LED, and the LED output at the specified distance is measured as 195 lumens, the voltage can be increased until the target value of 200 lumens is achieved (within a range that is acceptable). For purposes of illustration, if the initial applied voltage is 10V and the voltage that is found to cause the LED to meet the target output is 11V, then a calibration parameter could be derived, e.g., that the particular red LED produces a lower than expected output of approximately 2.5% per applied volt in a range near 10V. This calibration parameter could be stored and used for the particular red LED in different condition to meet other specified output conditions. For example, assuming linearity, if 205 lumens were desired from the LED, using the calibration parameter, it would be known that 12V is required. For a group of like color LEDs, such as in a LED board, the process can be repeated for each LED, producing one or more calibration parameters for that LED, which can be stored and used for subsequent operation of the LEDs. Similarly, the brightness level for green light can be set to 150 lumens, and all the green LEDs can be calibrated. The same applies to the blue LEDs. For example, the brightness level for blue light can be set to 180 lumens, and each blue LED can be calibrated by observing the voltage at which the specified brightness is met. The brightness levels for each primary color can be stored in a data repository. As a result of setting the brightness levels for red, green, and blue light, the brightness levels for other colors can also become consistent throughout the multiple light sources, as light of other colors can be generated using the red, green, and blue light according to the CIE 1931 XYZ Color Space, created by the International Commission on Illumination (CIE) in 1931. Also, it will be appreciated that groupings of LEDs (e.g., a group of RGB LEDs) may be calibrated together as opposed to having one LED from each group calibrated at one time.

For some applications and embodiments, a brightness meter can include any suitable photodetector. Examples include but are not limited to suitable CCD arrays and/or photodiode arrays (e.g., of two-dimensional (2D) or one-dimensional (1D) layout). Furthermore, dispersing optics such as one or more prisms or lenses may be used with/for such brightness meters, e.g., used to disperse different wavelengths of light for intensity measurement of discrete color bands/ranges.

In some embodiments, a brightness or color meter or measuring device can include one or more optical sensors that have/has been calibrated to a “stabilized” optical light source. For example, as LEDs commonly have a time-dependent variation in output intensity/color, which often asymptotically approaches as a certain level, LEDs may be used that have been “aged” or used for a certain amount of time, e.g., 1000 hrs, so as to achieve a stable or more stable output. Such light sources may be used to calibrate optical sensors that are used for calibration as described herein.

In addition to brightness, color can also be calibrated in a similar manner. For color calibration, groupings of LEDs (e.g., a group of RGB LEDs) may be calibrated together as opposed to having one LED from each group calibrated at one time (which, however, is also possible). As is described in further detail below, in some embodiments, the red color of one group of RGB LEDs can be measured by a suitable photodetector, with a red component from each diode being measured to arrive at a red-color calibration constant for each LED in the grouping. The color of each LED may be adjusted to a degree by adjusting current flow through the LED. Without limiting the utility of the present disclosure, it is believed that for LEDs of a particular color, the output color spectrum (and, hence, discernable color) is a (e.g., multivariable) function of current passing through the LED. Thus, some extent of color tuning may be available by adjusting the amount of current flowing through the LED (or other light source). Of course, while examples are described herein as having RGB groups of LEDs, any available color-type of LED may be used, alone or in any color combination for such light boards, displays, blocks, or other lighting structures (e.g., luminaires). Accordingly, lighting structure (e.g., LED boards) can be calibrated across the physically achievable color gamut achievable by the light sources (e.g., LEDs) used for the structure.

FIG. 1 illustrates an example of a system 100 for lighting calibration. As shown, the system 100 includes a light structure 110, a control machine 120, a brightness/color meter 130, and a remote computer 140.

In various embodiments, the light structure 110 can be or include any light structure, for example, a LED light structure, a liquid crystal display (LCD) light structure, a plasma light structure, a cathode ray tube (CRT) light structure, or any other known light structure. In some implementations, the light structure 110 is a LED light structure that includes multiple LED boards, each of which includes multiple LED blocks (e.g., blocks 115.1-6). A LED block can correspond to a LED light source. The LED light structure may be displayed, for example, in a stadium, in an entertainment arena, or on an outside wall of a building, among other places. The light structure 110 can display, at each block, light source, or other sub-unit of the light structure 110, light of a first color (e.g., red), light of a second color (e.g., green), light of a third color (e.g., blue), and light blended from light of the first color, light of the second color, and light of the third color. As a result, the light structure 110 can display colors from the CIE 1931 XYZ Color Space.

As illustrated, the light structure 110 includes multiple light blocks 115.1-6. While six light blocks 115.1-6 are shown, the light structure can include any number of light blocks 115. Each light block 115.k (where k is a number between 1 and 6) produces light for a part of the light structure 110. In some examples, the light structure 110 is a LED light structure and the light blocks 115.1-6 are LED blocks. Some example implementations of the light blocks 115.1-6 are described in greater detail below, for example, in conjunction with the description of FIG. 4 and FIG. 5.

The control machine 120 is configured to control the light structure 110. For example, the control machine 120 can transmit command(s) to the light structure 110 and modify the behavior of the light structure 110. In some examples, the control machine 120 is configured to control individual light block(s) 115.k in the light structure 110. The control machine 120 is configured to communicate with the light source 120 and the brightness/color meter 130 using one or more of a network connection, a wired connection, or a wireless connection. The network can include one or more of the Internet, a local area network (LAN), a wide area network (WAN), a wired network, a wireless network, etc. One example of the control machine 120 is described in detail in FIG. 2, below. In various embodiments, the control machine 120 can be or include one or more of a single processor computing device, a multiprocessor computing device, a mobile phone, a personal digital assistant (PDA), a personal digital music player, a tablet computer, a laptop computer, a desktop computer, a television with one or more processors embedded therein or coupled thereto, etc.

The brightness/color meter 130 can or include be any machine or sensor configured to detect and/or measure brightness or color. For example, the brightness/color meter 130 can be implemented using a special purpose brightness or color meter or a tablet computer, mobile phone, or other computing device having a brightness or color meter application. The brightness/color meter 130 can be operated manually by a technician. Alternatively, the brightness/color meter 130 can automatically detect brightness. Upon detecting the brightness of light of a specified color or the color of light from the light structure 110, the brightness/color meter 130 can transmit the detected brightness or color to the control machine 120. As illustrated in FIG. 1, a single brightness/color meter 130 functions as both the brightness meter and the color meter. However, in some implementations, two different machines, one serving as a brightness meter and another serving as a color meter, can be used in conjunction with the subject technology. The subject technology can be implemented with either a single brightness/color meter 130 or an array of brightness or color meters 130. In some implementations, each brightness or color meter in the array is responsible for measuring the brightness or color of an associated light block 115.k in the light structure 110.

As illustrated in FIG. 1, the brightness/color meter 130 is XYZ machine or a robot spectrometer. The XYZ machine/robot spectrometer can include a robotic spectrometer head to move across the LED targets (or other light blocks, e.g., light blocks 115.1-6) and precisely measure a chromaticity and a luminance of each LED target (or other light block) in a target LED matrix (or other light structure, e.g., light structure 110). The XYZ machine/robot spectrometer can include a graphical user interface (GUI), for example, a windows based GUI, to calculate the correction coefficients and factor for each pixel, LED target, or other light block, based on the measured data. Alternatively, the GUI and the calculations can be provided at the control machine 120 or the remote computer 140. In some examples, the brightness/color meter 130 is a robotic spectrometer system which can include a robot (e.g., JR2500 manufactured by Janome Company of Tokyo, Japan) and a spectrometer (e.g., SPM-002-A manufactured by Photon Control of Burnaby, British Columbia). The robot is configured to move the spectrometer across the light structure 110 and to measure the brightness and the color of each light block 115.k in the light structure 110.

The remote computer 140 is connected to the control machine 120, the brightness/color meter 130, and/or to the light structure 110, for example, via a network. The remote computer 140 can be used to transmit data (e.g., display data for the light structure 110) to the control machine 120 or to the light structure 110 or to remotely program the control machine 120 or the light structure 110. For example, the remote computer 140 can be used to provide software update(s) to the control machine 120 or the light structure 110 or to allow a remote programmer to debug or repair improperly operating software on the control machine 120 or on the light structure 110. In some implementations, the remote computer 140 can be used to control individual light block(s) 115.k of the light structure 110. In various embodiments, the remote computer 140 can be or include one or more of a single processor computing device, a multiprocessor computing device, a mobile phone, a personal digital assistant (PDA), a personal digital music player, a tablet computer, a laptop computer, a desktop computer, a television with one or more processors embedded therein or coupled thereto, etc.

FIG. 2 illustrates an example of the control machine 120 of FIG. 1. As shown, the control machine 120 may include a central processing unit (CPU) 202, a network interface 204, and a memory 206. The CPU 202 may include one or more processors. The CPU 202 is configured to execute computer instructions that are stored in a computer-readable storage medium, for example, the memory 206. The network interface 204 is configured to allow the computing device 200 to transmit and receive data in a network (e.g., the Internet, a wired network, a wireless local area network, or a wireless wide area network). The network interface 204 may include one or more network interface cards (NICs). The memory 206 stores data and/or instructions. As shown, the memory 206 includes a brightness calibration module 208, a first color brightness value 210, a second color brightness value 212, a third color brightness value 214, and a color output calibration module 216.

The brightness calibration module 208 is configured to detect a brightness level for a first color (e.g., red) for at least a first portion of multiple light sources (e.g., all or a part of the multiple light sources in the light structure 110). The brightness calibration module 208 is configured to set the brightness level for the first color for each of the multiple light sources to the first color brightness value 210, which may be selected based on the detected brightness levels for the first color for the multiple light sources. For example, the first color brightness value 210 may correspond to the average (e.g., mean) brightness level for the first color for the multiple light sources.

The brightness calibration module 208 is configured to detect a brightness level for a second color (e.g., green) for at least a second portion of multiple light sources (e.g., all or a part of the multiple light sources). The brightness calibration module 208 is configured to set the brightness level for the second color for each of the multiple light sources to the second color brightness value 212, which may be selected based on the detected brightness levels for the second color for the multiple light sources. For example, the second color brightness value 212 may correspond to the average (e.g., mean) brightness level for the second color for the multiple light sources.

The brightness calibration module 208 is configured to detect a brightness level for a third color (e.g., blue) for at least a third portion of multiple light sources (e.g., all or a part of the multiple light sources). The brightness calibration module 208 is configured to set the brightness level for the third color for each of the multiple light sources to the third color brightness value 214, which may be selected based on the detected brightness levels for the third color for the multiple light sources. For example, the third color brightness value 214 may correspond to the average (e.g., mean) brightness level for the third color for the multiple light sources. The brightness calibration module 208 may be configured to store the first color brightness value 210, the second color brightness value 212, and the third color brightness value 214 in the memory 206 of the control machine 120 and/or in a data repository external to the control machine 120.

The color output calibration module 216 is configured to calibrate color output among multiple light sources (e.g., multiple light blocks, e.g., LED blocks, in the light structure 110). In some examples, the color output calibration module 216 sets each of the multiple light sources to provide red light. The color output calibration module 216 determines, using a color meter (e.g., brightness/color meter 130), a red value for each of the multiple light sources. The red value for each light source can be the position of the red light from the light source in the CIE 1931 XYZ Color Space, for example, (0.65, 0.25). The color output calibration module 216 sets each of the multiple light sources to provide green light. The color output calibration module 216 determines, using the color meter (e.g., brightness/color meter 130), a green value for each of the multiple light sources. The green value for each light source can be the position of the green light in the CIE 1931 XYZ Color Space for the light source, for example, (0.7, 0.2). The color output calibration module 216 sets each of the multiple light sources to provide blue light. The color output calibration module 216 determines, using the color meter (e.g., brightness/color meter 130), a blue value for each of the multiple light sources. The blue value for each light source can be the position of the blue light in the CIE 1931 XYZ Color Space for the light source, for example, (0.15, 0.05). A color value for one of the three colors (e.g., red, green, or blue) from a first light source from the multiple light sources can be different from a color value for the same color from a second light source from the multiple light sources. The color output calibration module 216 stores, in a data store associated with a particular light source, the red color value, the green color value, and the blue color value of the particular light source.

FIG. 3 illustrates an example process 300 for lighting calibration. The process 300 begins at step 310, where a control machine (e.g., control machine 120, via operation of the brightness calibration module 208) detects a brightness level for a first color (e.g., red) for a first portion of multiple light sources (e.g., all or part of the light blocks in light structure 110). As will be appreciated, the color output spectrum of a particular LED results from the bandgap of the semiconductor alloy (set of material) used of the LED p-n junction or p-i-n junction; different semiconductor materials can provide different color spectra. Additionally, various coatings on or in the LED package may also contribute to the color output. For example, some phosphor coatings may convert blue light to white light. The multiple light sources can correspond to LED blocks in a LED display system. The control machine can detect the brightness level for the first color by setting or causing the first portion of the multiple light sources to display the first color and having a technician (or another person) operate a brightness meter (e.g., brightness/color meter 130) to determine or detect, using the brightness meter, the brightness level and transmit or input the determined brightness level to the control machine.

For some embodiments, a so-called X-Y table or machine may be used to facilitate color and/or brightness calibration of a lighting structure (e.g., LED block) in a manufacturing environment. Such a table/machine can offer or include computer-numeric-control (CNC) functionality. The X-Y machine can hold a sensor or sensors (e.g., 4 sensors in a rectangular array) at a known vertical (Z) distance from the X-Y plane (e.g., machine table top), on which the light structure (e.g., LED board) that is to be calibrated is held or located. The X-Y machine can operate to move the LED board (or other lighting structure) in a desired (e.g., programmed) path such that measurements (using the sensor(s) at the Z-axis location(s)) can be and are obtained at desired locations (relative to the X-Y plane). These measurement can be used for calibration (e.g., color and/or brightness) of the light sources (e.g., LEDs) of the light structure; corresponding calibration parameters can be obtained, as described herein, and stored/used for the light structure in subsequent use, e.g., in intended use application outside of the manufacturing environment, including for use with replacement parts/components for the light structure. Any suitable X-Y machine may be used; further, a personal computer may control or facilitate control of the movement of the X-Y table (or sensors) and/or the recording or data acquisition of data from the sensor(s) during the measurement/sensing process; this data can then be used for calibration.

In some examples, a lighting structure (e.g., light structure 110) with multiple LED bulbs is configured to output light derived from combination(s) of red, green, or blue light. The brightness of red light (Rₒᵤₜ), green light (Gₒᵤₜ), or blue light (Bₒᵤₜ) can be calculated according to equations (1)-(3).

Rₒᵤₜ=k_{RR}R+k_{RG}G+k_{RB}B (1)

Gₒᵤₜ=k_{GR}R+k_{GG}G+k_{GB}B (2)

Bₒᵤₜ=k_{BR}R+k_{BG}G+k_{BB}B (3)

In equations (1)-(3), k represent coefficients, and R, G, and B represent an electric current to red, green, or blue LEDs in the LED light blocks.

In step 320, the control machine sets the brightness level to a desired value, adjusting the operational parameters of the lights sources to reach that desired values. Calibration parameters can be generated from this process and used for the light sources. For example, for the first color for each of the multiple light sources to a first color brightness value (e.g., first color brightness value 210). The first color brightness value is selected based on the detected brightness level for the first color for the first portion of the multiple light sources. For example, the first color brightness value can correspond to a certain value (e.g., a peak or mean value) of the detected brightness levels for the first color for the first portion of the multiple light sources. The brightness level for the first color for each of the multiple light sources can be set by adjusting (e.g., increasing or decreasing) an electric current to a light emitting diode bulb or any other light bulb for the first color for each of the plurality of light sources.

In step 330, the control machine detects a brightness level for a second color (e.g., green) for a second portion of the multiple light sources. Step 330 can be implemented in a similar manner to step 310.

In step 340, the control machine sets the brightness level for the second color for each of the multiple light sources to a second color brightness value (e.g., second color brightness value 212). The second color brightness value is selected based on the detected brightness level for the second color for the second portion of the multiple light sources. Step 340 can be implemented in a similar manner to step 320.

In step 350, the control machine detects a brightness level for a third color (e.g., blue) for a third portion of the multiple light sources. Step 350 can be implemented in a similar manner to step 310.

In step 360, the control machine sets the brightness level for the third color for each of the multiple light sources to a third color brightness value (e.g., third color brightness value 214). The third color brightness value is selected based on the detected brightness level for the third color for the third portion of the multiple light sources. Step 360 can be implemented in a similar manner to step 320.

In step 370, the control machine stores, in a data store (e.g., the memory 206 of the control machine 120 or a data repository external to the control machine 120), the first color brightness value, the second color brightness value, and the third color brightness value. After step 370, the process 300 ends.

FIG. 4 illustrates an example of the light structure 110 of FIG. 1. As shown, the light structure 110 includes light source(s) 410.1-n. The light source(s) 410.1-n can correspond to the light blocks 115.1-6 illustrated in FIG. 1, where each one light source can correspond to one light block. For example, the light structure 110 can include multiple LED boards, and each LED board can include multiple LED blocks. Each light source 410.k (where k is a number between 1 and n) can correspond to one of the LED blocks. An example light source 410.k is described in greater detail in conjunction with FIG. 5.

FIG. 5 illustrates an example of the light source 410.k of FIG. 4. As shown, the light source 410.k includes a first color (e.g., red) bulb 510, a second color (e.g., green) bulb 520, a third color (e.g., blue) bulb 530, and a memory 540. Each of the first color bulb 510, the second color bulb 520, and the third color bulb 530 is associated with a current, 515, 525, and 535, respectively, passing through the bulb. The current 515, 525, or 535 of a bulb 510, 520, or 530, respectively, can be adjusted to adjust the brightness of the bulb. For example, if the current is increased then the brightness is increased and if the current is decreased then the brightness is decreased. The memory 540 stores data and/or instructions. As shown, the memory 540 includes a first color CIE color space value 550, a second color CIE color space value 560, and a third color CIE color space value 570.

The first color CIE color space value 550 corresponds to a position on the CIE 1931 XYZ Color Space of light of the first color (e.g., red) from the first color bulb 510, which may be measured using a color meter (e.g., brightness/color meter 130) and stored in the memory 540 as described herein. Two different light sources from among the light source(s) 410.1-n can have the same first color CIE color space value 550 or different first color CIE color space values 550. The different first color CIE color space values 550 can result from, for example, different manufacture dates, different usage, or different decay rates of the two different light sources.

The second color CIE color space value 560 corresponds to a position on the CIE 1931 XYZ Color Space of light of the second color (e.g., green) from the second color bulb 520, which may be measured using a color meter (e.g., brightness/color meter 130) and stored in the memory 540 as described herein. Two different light sources from among the light source(s) 410.1-n can have the same second color CIE color space value 560 or different second color CIE color space values 560. The different second color CIE color space values 560 can result from, for example, different manufacture dates, different usage, or different decay rates of the two different light sources.

The third color CIE color space value 570 corresponds to a position on the CIE 1931 XYZ Color Space of light of the third color (e.g., blue) from the third color bulb 530, which may be measured using a color meter (e.g., brightness/color meter 130) and stored in the memory 540 as described herein. Two different light sources from among the light source(s) 410.1-n can have the same third color CIE color space value 570 or different third color CIE color space values 570. The different third color CIE color space values 570 can result from, for example, different manufacture dates, different usage, or different decay rates of the two different light sources.

While the subject technology is described herein using the CIE 1931 XYZ Color Space, any other color space can be used in conjunction with the subject technology in place of the CIE 1931 XYZ Color Space. The CIE 1931 XYZ Color Space is one example color space with which the subject technology may be implemented.

FIG. 6 illustrates an example process 600 for calibrating brightness among multiple light sources. The process 600 begins at step 610, where a control machine (e.g., control machine 120, via operation of the brightness calibration module 208) detects a brightness level for a first color (e.g., red), a brightness level for a second color (e.g., green), and a brightness level for a third color (e.g., blue) for at least a portion of multiple light sources (e.g., light source(s) 410.1-n in light structure 110). The control machine can detect the brightness levels by receiving data from a brightness meter (e.g., brightness/color meter 130) operated by a technician. The portion of the multiple light sources can be caused to display light of the first color, the second color, or the third color, and the brightness level of the displayed light of the first color, the second color, or the third color, respectively, can be measured. The multiple light sources can be LED blocks in a LED display structure.

In step 620, the control machine determines a desired brightness value for the first color (e.g., first color brightness value 210) based on the detected brightness level(s) for the first color. In some examples, the desired brightness value for the first color is below each of the detected brightness level(s) for the first color, as light bulbs can be dimmed but may not be able to easily be brightened.

In step 630, the control machine determines a desired brightness value for the second color (e.g., second color brightness value 212) based on the detected brightness level(s) for the second color. In some examples, the desired brightness value for the second color is below each of the detected brightness level(s) for the second color, as light bulbs can be dimmed but may not be able to easily be brightened.

In step 640, the control machine determines a desired brightness value for the third color (e.g., third color brightness value 214) based on the detected brightness level(s) for the third color. In some examples, the desired brightness value for the third color is below each of the detected brightness level(s) for the third color, as light bulbs can be dimmed but may not be able to easily be brightened. The desired brightness values for the first color, the second color, or the third color can be stored in a data store (e.g., in the memory 206).

In step 650, the control machine adjusts one or more currents (e.g., one or more of the currents 515, 525, or 535) at the multiple light sources to set the multiple light sources to the desired brightness value for the first color, the desired brightness value for the second color, and the desired brightness value for the third color. After step 650, the process 600 ends.

The light sources are described above as presenting light of either the first color, the second color, or the third color. However, in some examples, at least one of the light sources may be caused to display light blended from light of the first color, light of the second color, or light of the third color. For example, yellow light can be created by blending red light and green light.

FIGS. 7A-7B illustrates an example process 700 for calibrating color output among multiple light sources. As shown in FIG. 7A, the process 700 begins at step 705, where a control machine (e.g., control machine 120, via operation of the color output calibration module 216) sets each of multiple light sources (e.g., light source(s) 410.1-n in light structure 110) to provide light of a first color (e.g., red). The multiple light sources can correspond to multiple LED blocks in a LED display structure. The LED display structure can include at least two LED boards. A first LED board from among the at least two LED boards can have a different color intensity decay rate than a second LED board from among the at least two LED boards.

In step 710, the control machine determines, using a color meter, (e.g., the brightness/color meter 130, which may be operated by a technician) a first color value (e.g., first color CIE color space value 550) for each of the multiple light sources. The first color value for a particular light source (e.g., light source 410.k) corresponds to a color output from the particular light source responsive to setting the particular light source to provide light of the first color. The first color value can correspond to a position in a color space, for example, a coordinate position in the CIE 1931 XYZ Color Space. The first color value for a first light source from among the multiple light sources can be different from the first color value for a second light source from among the multiple light sources.

In step 715, the control machine sets each of the multiple light sources to provide light of a second color (e.g., green). In step 720, the control machine determines, using the color meter, a second color value (e.g., second color CIE color space value 560) for each of the multiple light sources. The second color value for the particular light source corresponds to a color output from the particular light source responsive to setting the particular light source to provide light of the second color. The second color value can correspond to a position in a color space, for example, a coordinate position in the CIE 1931 XYZ Color Space. The second color value for a first light source from among the multiple light sources can be different from the second color value for a second light source from among the multiple light sources.

In step 725, the control machine sets each of the multiple light sources to provide light of a third color (e.g., blue). In step 730, the control machine determines, using the color meter, a third color value (e.g., third color CIE color space value 570) for each of the multiple light sources. The third color value for the particular light source corresponds to a color output from the particular light source responsive to setting the particular light source to provide light of the third color. The third color value can correspond to a position in a color space, for example, a coordinate position in the CIE 1931 XYZ Color Space. The third color value for a first light source from among the multiple light sources can be different from the third color value for a second light source from among the multiple light sources.

In step 735, the control machine stores the first color value, the second color value, and the third color value for each of the multiple light sources. The first color value for the particular light source, the second color value for the particular light source, and the third color value for the particular light source are stored in a data store coupled with the particular light source (e.g., the memory 540 of the light source 410.k).

As shown in FIG. 7B, in step 740, the control machine receives an input for the particular light source to provide light of a combined color (e.g., yellow). The combined color is different from the first color, different from the second color, and different from the third color.

In step 745, the control machine determines, based on the first color value for the particular light source, the second color value for the particular light source, and the third color value for the particular light source, a combination of the light of the first color at the particular light source, the light of the second color at the particular light source, and the light of the third color at the particular light source to reach the combined color. As different light sources have different first color values, second color values, or third color values, the different light sources can have different combinations of the light of the first color, the light of the second color, and the light of the third color to reach the combined color.

In step 750, the control machine sets, in response to the received input for the particular light source to provide the light of the combined color, the particular light source to provide light according to the combination of the light of the first color at the particular light source, the light of the second color at the particular light source, and the light of the third color at the particular light source. After step 750, the process 700 ends.

The subject technology is illustrated, for example, according to various aspects described below. Various examples of the subject technology are described as numbered clauses (1, 2, 3, etc.) for convenience. These are provided as examples, and do not limit the subject technology.

1. A computer-implemented method for calibrating brightness among a plurality of light sources, the method comprising:

detecting a brightness level for a first color, a brightness level for a second color, and a brightness level for a third color for at least a portion of the plurality of light sources;

determining a desired brightness value for the first color based on the detected brightness level for the first color;

determining a desired brightness value for the second color based on the detected brightness level for the second color;

determining a desired brightness value for the third color based on the detected brightness level for the third color; and

adjusting one or more currents at the plurality of light sources to set the plurality of light sources to the desired brightness value for the first color, the desired brightness value for the second color, and the desired brightness value for the third color.

2. The method of clause 1, wherein determining the desired brightness value for the first color comprises:

determining the desired brightness value for the first color below each of the detected brightness levels for the first color.

3. The method of clause 1, wherein the first color, the second color, and the third color comprise red, green, and blue.

4. The method of clause 1, wherein the plurality of light sources comprise light emitting diode blocks in a light emitting diode display structure.

5. The method of clause 1, wherein detecting the brightness level for the first color for the at least the first portion of the plurality of light sources comprises:

causing the first portion of the plurality of light sources to display light of the first color; and

measuring the brightness level of the displayed light of the first color.

6. The method of clause 1, further comprising:

causing at least one light source from the plurality of light sources to display light blended from light of the first color, light of the second color, and light of the third color.

7. The method of clause 1, further comprising:

storing, in a data store, the desired brightness value for the first color, the desired brightness value for the second color, and the desired brightness value for the third color.

8. A non-transitory computer-readable medium comprising instructions to calibrate brightness among a plurality of light sources, the instructions comprising code to:

detect a brightness level for a first color, a brightness level for a second color, and a brightness level for a third color for at least a portion of the plurality of light sources;

determine a desired brightness value for the first color based on the detected brightness level for the first color;

determine a desired brightness value for the second color based on the detected brightness level for the second color;

determine a desired brightness value for the third color based on the detected brightness level for the third color; and

adjust one or more currents at the plurality of light sources to set the plurality of light sources to the desired brightness value for the first color, the desired brightness value for the second color, and the desired brightness value for the third color.

9. The computer-readable medium of clause 8, wherein the code to determine the desired brightness value for the first color comprises code to:

determining the desired brightness value for the first color below each of the detected brightness levels for the first color.

10. The computer-readable medium of clause 8, wherein the first color, the second color, and the third color comprise red, green, and blue.

11. The computer-readable medium of clause 8, wherein the plurality of light sources comprise light emitting diode blocks in a light emitting diode display structure.

12. The computer-readable medium of clause 8, wherein the code to detect the brightness level for the first color for the at least the first portion of the plurality of light sources comprises code to:

cause the first portion of the plurality of light sources to display light of the first color; and

measure the brightness level of the displayed light of the first color.

13. The computer-readable medium of clause 8, the instructions further comprising code to:

cause at least one light source from the plurality of light sources to display light blended from light of the first color, light of the second color, and light of the third color.

14. The method of clause 1, the instructions further comprising code to:

store, in a data store, the desired brightness value for the first color, the desired brightness value for the second color, and the desired brightness value for the third color.

15. A system for calibrating brightness among a plurality of light sources, the system comprising:

one or more processors; and

a memory comprising instructions which, when executed by the one or more processors, cause the one or more processors to:
detect a brightness level for a first color, a brightness level for a second color, and a brightness level for a third color for at least a portion of the plurality of light sources;
determine a desired brightness value for the first color based on the detected brightness level for the first color;
determine a desired brightness value for the second color based on the detected brightness level for the second color;
determine a desired brightness value for the third color based on the detected brightness level for the third color; and
adjust one or more currents at the plurality of light sources to set the plurality of light sources to the desired brightness value for the first color, the desired brightness value for the second color, and the desired brightness value for the third color.

16. The system of clause 15, wherein the instructions to determine the desired brightness value for the first color comprise instructions to:

determining the desired brightness value for the first color below each of the detected brightness levels for the first color.

17. The system of clause 15, wherein the first color, the second color, and the third color comprise red, green, and blue.

18. The system of clause 15, wherein the plurality of light sources comprise light emitting diode blocks in a light emitting diode display structure.

19. The system of clause 15, wherein the instructions to detect the brightness level for the first color for the at least the first portion of the plurality of light sources comprise instructions to:

cause the first portion of the plurality of light sources to display light of the first color; and

measure the brightness level of the displayed light of the first color.

20. The system of clause 15, the memory further comprising instructions which, when executed by the one or more processors, cause the one or more processors to:

cause at least one light source from the plurality of light sources to display light blended from light of the first color, light of the second color, and light of the third color.

21. The system of clause 15, the memory further comprising instructions which, when executed by the one or more processors, cause the one or more processors to:

store, in a data store, the desired brightness value for the first color, the desired brightness value for the second color, and the desired brightness value for the third color.

22. A computer-implemented method for calibrating color output among a plurality of light sources, the method comprising:

setting each of a plurality of light sources to provide light of a first color;

determining, using a color meter, a first color value for each of the plurality of light sources, wherein the first color value for a particular light source from among the plurality of light sources corresponds to a color output from the particular light source responsive to setting the particular light source to provide the light of the first color;

setting each of the plurality of light sources to provide light of a second color;

determining, using the color meter, a second color value for each of the plurality of light sources, wherein the second color value for the particular light source corresponds to a color output from the particular light source responsive to setting the particular light source to provide the light of the second color;

setting each of the plurality of light sources to provide light of a third color;

determining, using the color meter, a third color value for each of the plurality of light sources, wherein the third color value for a particular light source corresponds to a color output from the particular light source responsive to setting the particular light source to provide the light of the third color; and

storing the first color value, the second color value, and the third color value for each of the plurality of light sources, wherein the first color value for the particular light source, the second color value for the particular light source, and the third color value for the particular light source are stored in a data store coupled with the particular light source.

23. The method of clause 22, further comprising:

receiving an input for the particular light source to provide light of a combined color, the combined color being different from the first color, different from the second color, and different from the third color;

determining, based on the first color value for the particular light source, the second color value for the particular light source, and the third color value for the particular light source, a combination of the light of the first color at the particular light source, the light of the second color at the particular light source, and the light of the third color at the particular light source to reach the combined color; and

setting, in response to the received input for the particular light source to provide the light of the combined color, the particular light source to provide light according to the combination of the light of the first color at the particular light source, the light of the second color at the particular light source, and the light of the third color at the particular light source.

24. The method of clause 22, wherein the first color, the second color, and the third color comprise red, green, and blue.

25. The method of clause 22, wherein each first color value, second color value, and third color value comprises a coordinate position in a CIE 1931 XYZ Color Space.

26. The method of clause 22, wherein the first color value for a first light source from the plurality of light sources is different from the first color value for a second light source from the plurality of light sources.

27. The method of clause 22, wherein the plurality of light sources comprise a plurality of light emitting diode (LED) blocks in a LED display structure, and wherein the particular light source comprises a particular LED block from among the plurality of LED blocks.

28. The method of clause 27, wherein the plurality of LED blocks are from at least two LED boards, wherein a first LED board from among the at least two LED boards has a different color intensity decay rate than a second LED board from among the at least two LED boards.

29. A non-transitory computer-readable medium comprising instructions to calibrate color output among a plurality of light sources, the instructions comprising code to:

set each of a plurality of light sources to provide light of a first color;

determine, using a color meter, a first color value for each of the plurality of light sources, wherein the first color value for a particular light source from among the plurality of light sources corresponds to a color output from the particular light source responsive to setting the particular light source to provide the light of the first color;

set each of the plurality of light sources to provide light of a second color;

determine, using the color meter, a second color value for each of the plurality of light sources, wherein the second color value for the particular light source corresponds to a color output from the particular light source responsive to setting the particular light source to provide the light of the second color;

set each of the plurality of light sources to provide light of a third color;

determine, using the color meter, a third color value for each of the plurality of light sources, wherein the third color value for a particular light source corresponds to a color output from the particular light source responsive to setting the particular light source to provide the light of the third color; and

store the first color value, the second color value, and the third color value for each of the plurality of light sources, wherein the first color value for the particular light source, the second color value for the particular light source, and the third color value for the particular light source are stored in a data store coupled with the particular light source.

30. The computer-readable medium of clause 29, the instructions further comprising code to:

receive an input for the particular light source to provide light of a combined color, the combined color being different from the first color, different from the second color, and different from the third color;

determine, based on the first color value for the particular light source, the second color value for the particular light source, and the third color value for the particular light source, a combination of the light of the first color at the particular light source, the light of the second color at the particular light source, and the light of the third color at the particular light source to reach the combined color; and

set, in response to the received input for the particular light source to provide the light of the combined color, the particular light source to provide light according to the combination of the light of the first color at the particular light source, the light of the second color at the particular light source, and the light of the third color at the particular light source.

31. The computer-readable medium of clause 29, wherein the first color, the second color, and the third color comprise red, green, and blue.

32. The computer-readable medium of clause 29, wherein each first color value, second color value, and third color value comprises a coordinate position in a CIE 1931 XYZ Color Space.

33. The computer-readable medium of clause 29, wherein the first color value for a first light source from the plurality of light sources is different from the first color value for a second light source from the plurality of light sources.

34. The computer-readable medium of clause 29, wherein the plurality of light sources comprise a plurality of light emitting diode (LED) blocks in a LED display structure, and wherein the particular light source comprises a particular LED block from among the plurality of LED blocks.

35. The computer-readable medium of clause 34, wherein the plurality of LED blocks are from at least two LED boards, wherein a first LED board from among the at least two LED boards has a different color intensity decay rate than a second LED board from among the at least two LED boards.

36. A system for calibrating color output among a plurality of light sources, the system comprising:

one or more processors; and

a memory comprising instructions which, when executed by the one or more processors, cause the one or more processors to:
set each of a plurality of light sources to provide light of a first color;
determine, using a color meter, a first color value for each of the plurality of light sources, wherein the first color value for a particular light source from among the plurality of light sources corresponds to a color output from the particular light source responsive to setting the particular light source to provide the light of the first color;
set each of the plurality of light sources to provide light of a second color;
determine, using the color meter, a second color value for each of the plurality of light sources, wherein the second color value for the particular light source corresponds to a color output from the particular light source responsive to setting the particular light source to provide the light of the second color;
set each of the plurality of light sources to provide light of a third color;
determine, using the color meter, a third color value for each of the plurality of light sources, wherein the third color value for a particular light source corresponds to a color output from the particular light source responsive to setting the particular light source to provide the light of the third color; and
store the first color value, the second color value, and the third color value for each of the plurality of light sources, wherein the first color value for the particular light source, the second color value for the particular light source, and the third color value for the particular light source are stored in a data store coupled with the particular light source.

37. The system of clause 36, the memory further comprising instructions which, when executed by the one or more processors, cause the one or more processors to:

receive an input for the particular light source to provide light of a combined color, the combined color being different from the first color, different from the second color, and different from the third color;

determine, based on the first color value for the particular light source, the second color value for the particular light source, and the third color value for the particular light source, a combination of the light of the first color at the particular light source, the light of the second color at the particular light source, and the light of the third color at the particular light source to reach the combined color; and

set, in response to the received input for the particular light source to provide the light of the combined color, the particular light source to provide light according to the combination of the light of the first color at the particular light source, the light of the second color at the particular light source, and the light of the third color at the particular light source.

38. The system of clause 36, wherein the first color, the second color, and the third color comprise red, green, and blue.

39. The system of clause 36, wherein each first color value, second color value, and third color value comprises a coordinate position in a CIE 1931 XYZ Color Space.

40. The system of clause 36, wherein the first color value for a first light source from the plurality of light sources is different from the first color value for a second light source from the plurality of light sources.

41. The system of clause 36, wherein the plurality of light sources comprise a plurality of light emitting diode (LED) blocks in a LED display structure, and wherein the particular light source comprises a particular LED block from among the plurality of LED blocks.

42. The system of clause 41, wherein the plurality of LED blocks are from at least two LED boards, wherein a first LED board from among the at least two LED boards has a different color intensity decay rate than a second LED board from among the at least two LED boards.

FIG. 8 conceptually illustrates an electronic system 800 with which some implementations of the subject technology are implemented. For example, one or more of the control machine 120, the brightness/color meter 130, or the remote computer 140 may be implemented using the arrangement of the electronic system 800. The electronic system 800 can be a computer (e.g., a mobile phone, PDA), or any other sort of electronic device. Such an electronic system includes various types of computer readable media and interfaces for various other types of computer readable media. Electronic system 800 includes a bus 805, processing unit(s) 810, a system memory 815, a read-only memory 820, a permanent storage device 825, an input device interface 830, an output device interface 835, and a network interface 840.

The bus 805 collectively represents all system, peripheral, and chipset buses that communicatively connect the numerous internal devices of the electronic system 800. For instance, the bus 805 communicatively connects the processing unit(s) 810 with the read-only memory 820, the system memory 815, and the permanent storage device 825.

From these various memory units, the processing unit(s) 810 retrieves instructions to execute and data to process in order to execute the processes of the subject technology. The processing unit(s) can be a single processor or a multi-core processor in different implementations.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some implementations of the subject technology use a mass-storage device (for example a magnetic or optical disk and its corresponding disk drive) as the permanent storage device 825.

Other implementations use a removable storage device (for example a floppy disk, flash drive, and its corresponding disk drive) as the permanent storage device 825. Like the permanent storage device 825, the system memory 815 is a read-and-write memory device. However, unlike storage device 825, the system memory 815 is a volatile read-and-write memory, such a random access memory. The system memory 815 stores some of the instructions and data that the processor needs at runtime. In some implementations, the processes of the subject technology are stored in the system memory 815, the permanent storage device 825, or the read-only memory 820. For example, the various memory units include instructions for calibrating lighting sources for intensity and color in accordance with some implementations. From these various memory units, the processing unit(s) 810 retrieves instructions to execute and data to process in order to execute the processes of some implementations.

The bus 805 also connects to the input and output device interfaces 830 and 835. The input device interface 830 enables the user to communicate information and select commands to the electronic system. Input devices used with input device interface 830 include, for example, alphanumeric keyboards and pointing devices (also called “cursor control devices”). Output device interfaces 835 enables, for example, the display of images generated by the electronic system 800. Output devices used with output device interface 835 include, for example, printers and display devices, for example cathode ray tubes (CRT) or liquid crystal displays (LCD). Some implementations include devices for example a touch screen that functions as both input and output devices.

Finally, as shown in FIG. 8, bus 805 also couples electronic system 800 to a network (not shown) through a network interface 840. In this manner, the electronic system 800 can be a part of a network of computers (for example a local area network (“LAN”), a wide area network (“WAN”), or an Intranet, or a network of networks, for example the Internet. Any or all components of electronic system 800 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself

As used in this specification and any claims of this application, the terms “computer,” “server,” “processor,” and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A non-transitory computer-readable medium comprising instructions to calibrate brightness among a plurality of light sources, the instructions comprising code to:
detect a brightness level for a first color, a brightness level for a second color, and a brightness level for a third color for at least a portion of the plurality of light sources;
determine a desired brightness value for the first color based on the detected brightness level for the first color;
determine a desired brightness value for the second color based on the detected brightness level for the second color;
determine a desired brightness value for the third color based on the detected brightness level for the third color; and
adjust one or more currents at the plurality of light sources to set the plurality of light sources to the desired brightness value for the first color, the desired brightness value for the second color, and the desired brightness value for the third color.

2. The computer-readable medium of claim 1, wherein the code to determine the desired brightness value for the first color comprises code to:
determining the desired brightness value for the first color below each of the detected brightness levels for the first color.

3. The computer-readable medium of claim 1, wherein the first color, the second color, and the third color comprise red, green, and blue.

4. The computer-readable medium of claim 1, wherein the plurality of light sources comprise light emitting diode blocks in a light emitting diode display structure.

5. The computer-readable medium of claim 1, wherein the code to detect the brightness level for the first color for the at least the first portion of the plurality of light sources comprises code to:
cause the first portion of the plurality of light sources to display light of the first color; and
measure the brightness level of the displayed light of the first color.

6. The computer-readable medium of claim 1, the instructions further comprising code to:
cause at least one light source from the plurality of light sources to display light blended from light of the first color, light of the second color, and light of the third color.

7. The computer-readable medium of claim 1, the instructions further comprising code to:
store, in a data store, the desired brightness value for the first color, the desired brightness value for the second color, and the desired brightness value for the third color.

8. A system for calibrating brightness among a plurality of light sources, the system comprising:
one or more processors; and
a memory comprising instructions which, when executed by the one or more processors, cause the one or more processors to:
detect a brightness level for a first color, a brightness level for a second color, and a brightness level for a third color for at least a portion of the plurality of light sources;
determine a desired brightness value for the first color based on the detected brightness level for the first color;
determine a desired brightness value for the second color based on the detected brightness level for the second color;
determine a desired brightness value for the third color based on the detected brightness level for the third color; and
adjust one or more currents at the plurality of light sources to set the plurality of light sources to the desired brightness value for the first color, the desired brightness value for the second color, and the desired brightness value for the third color.

9. The system of claim 8, wherein the instructions to determine the desired brightness value for the first color comprise instructions to:
determining the desired brightness value for the first color below each of the detected brightness levels for the first color.

10. The system of claim 8, wherein the first color, the second color, and the third color comprise red, green, and blue.

11. The system of claim 8, wherein the plurality of light sources comprise light emitting diode blocks in a light emitting diode display structure.

12. The system of claim 8, wherein the instructions to detect the brightness level for the first color for the at least the first portion of the plurality of light sources comprise instructions to:
cause the first portion of the plurality of light sources to display light of the first color; and
measure the brightness level of the displayed light of the first color.

13. The system of claim 8, the memory further comprising instructions which, when executed by the one or more processors, cause the one or more processors to:
cause at least one light source from the plurality of light sources to display light blended from light of the first color, light of the second color, and light of the third color.

14. The system of claim 8, the memory further comprising instructions which, when executed by the one or more processors, cause the one or more processors to:
store, in a data store, the desired brightness value for the first color, the desired brightness value for the second color, and the desired brightness value for the third color.

15. A non-transitory computer-readable medium comprising instructions to calibrate color output among a plurality of light sources, the instructions comprising code to:
set each of a plurality of light sources to provide light of a first color;
determine, using a color meter, a first color value for each of the plurality of light sources, wherein the first color value for a particular light source from among the plurality of light sources corresponds to a color output from the particular light source responsive to setting the particular light source to provide the light of the first color;
set each of the plurality of light sources to provide light of a second color;
determine, using the color meter, a second color value for each of the plurality of light sources, wherein the second color value for the particular light source corresponds to a color output from the particular light source responsive to setting the particular light source to provide the light of the second color;
set each of the plurality of light sources to provide light of a third color;
determine, using the color meter, a third color value for each of the plurality of light sources, wherein the third color value for a particular light source corresponds to a color output from the particular light source responsive to setting the particular light source to provide the light of the third color; and
store the first color value, the second color value, and the third color value for each of the plurality of light sources, wherein the first color value for the particular light source, the second color value for the particular light source, and the third color value for the particular light source are stored in a data store coupled with the particular light source.

16. The computer-readable medium of claim 15, the instructions further comprising code to:
receive an input for the particular light source to provide light of a combined color, the combined color being different from the first color, different from the second color, and different from the third color;
determine, based on the first color value for the particular light source, the second color value for the particular light source, and the third color value for the particular light source, a combination of the light of the first color at the particular light source, the light of the second color at the particular light source, and the light of the third color at the particular light source to reach the combined color; and
set, in response to the received input for the particular light source to provide the light of the combined color, the particular light source to provide light according to the combination of the light of the first color at the particular light source, the light of the second color at the particular light source, and the light of the third color at the particular light source.

17. The computer-readable medium of claim 15, wherein the first color, the second color, and the third color comprise red, green, and blue.

18. The computer-readable medium of claim 15, wherein each first color value, second color value, and third color value comprises a coordinate position in a CIE 1931 XYZ Color Space.

19. The computer-readable medium of claim 15, wherein the first color value for a first light source from the plurality of light sources is different from the first color value for a second light source from the plurality of light sources.

20. The computer-readable medium of claim 15, wherein the plurality of light sources comprise a plurality of light emitting diode (LED) blocks in a LED display structure, and wherein the particular light source comprises a particular LED block from among the plurality of LED blocks.

21. The computer-readable medium of claim 20, wherein the plurality of LED blocks are from at least two LED boards, wherein a first LED board from among the at least two LED boards has a different color intensity decay rate than a second LED board from among the at least two LED boards.

22. A system for calibrating color output among a plurality of light sources, the system comprising:
one or more processors; and
a memory comprising instructions which, when executed by the one or more processors, cause the one or more processors to:
set each of a plurality of light sources to provide light of a first color;
determine, using a color meter, a first color value for each of the plurality of light sources, wherein the first color value for a particular light source from among the plurality of light sources corresponds to a color output from the particular light source responsive to setting the particular light source to provide the light of the first color;
set each of the plurality of light sources to provide light of a second color;
determine, using the color meter, a second color value for each of the plurality of light sources, wherein the second color value for the particular light source corresponds to a color output from the particular light source responsive to setting the particular light source to provide the light of the second color;
set each of the plurality of light sources to provide light of a third color;
determine, using the color meter, a third color value for each of the plurality of light sources, wherein the third color value for a particular light source corresponds to a color output from the particular light source responsive to setting the particular light source to provide the light of the third color; and
store the first color value, the second color value, and the third color value for each of the plurality of light sources, wherein the first color value for the particular light source, the second color value for the particular light source, and the third color value for the particular light source are stored in a data store coupled with the particular light source.

23. The system of claim 22, the memory further comprising instructions which, when executed by the one or more processors, cause the one or more processors to:
receive an input for the particular light source to provide light of a combined color, the combined color being different from the first color, different from the second color, and different from the third color;
determine, based on the first color value for the particular light source, the second color value for the particular light source, and the third color value for the particular light source, a combination of the light of the first color at the particular light source, the light of the second color at the particular light source, and the light of the third color at the particular light source to reach the combined color; and
set, in response to the received input for the particular light source to provide the light of the combined color, the particular light source to provide light according to the combination of the light of the first color at the particular light source, the light of the second color at the particular light source, and the light of the third color at the particular light source.

24. The system of claim 22, wherein the first color, the second color, and the third color comprise red, green, and blue.

25. The system of claim 22, wherein each first color value, second color value, and third color value comprises a coordinate position in a CIE 1931 XYZ Color Space.

26. The system of claim 22, wherein the first color value for a first light source from the plurality of light sources is different from the first color value for a second light source from the plurality of light sources.

27. The system of claim 22, wherein the plurality of light sources comprise a plurality of light emitting diode (LED) blocks in a LED display structure, and wherein the particular light source comprises a particular LED block from among the plurality of LED blocks.

28. The system of claim 27, wherein the plurality of LED blocks are from at least two LED boards, wherein a first LED board from among the at least two LED boards has a different color intensity decay rate than a second LED board from among the at least two LED boards.
